(19) United States
(12) Patent Application Publication
(10) Pub. No.: US 2009/0228399 A1
(43) Pub. Date: Sep. 10, 2009

(54) METHOD OF PRESENTING PREDICTIVE DATA INCLUDING STANDARD DEVIATION OF FINANCIAL SECURITIES

(76) Inventors: Laurence A. Connors, New York, NY (US); Cesar Alvarez, Kirkland, WA (US)

Correspondence Address: STETINA BRUNDA GARRED & BRUCKER, 75 ENTERPRISE, SUITE 250, ALISO VIEJO, CA, 92656, US

(21) Appl. No.: 12/042,123

(22) Filed: Mar. 4, 2008

(51) Int. Cl. G06Q 40/00

(52) U.S. Cl. 705/36 R

(57) ABSTRACT

A method of presenting historical and predictive data of a security comprises the steps of displaying the historical data of the security on a user interface. The method further includes displaying a target value of the security. The method may also include displaying incrementally greater and lesser values expressed as a percentage of the target value of the security. The method further includes displaying predictive data for the current price wherein the predictive data includes an edge expressed as an increase or decrease in the current price predicted to occur at the end of a hold period. The method further includes displaying at least one standard deviation from the edge for the hold period on the user interface.

### CROSS-REFERENCE TO RELATED APPLICATIONS

This application is related to pending U.S. patent application Ser. No. 11/845,236 and entitled, METHOD OF PRESENTING PREDICTIVE DATA OF FINANCIAL SECURITIES, the entire contents of which is incorporated by reference herein.

### STATEMENT RE: FEDERALLY SPONSORED RESEARCH/DEVELOPMENT

(Not Applicable)

### BACKGROUND

The present invention relates generally to the trading of financial instruments and, more particularly, to a method of presenting predictive data such as predicted changes in the price of a security as a means for profiting from trading (i.e., buying and selling) of the security.

Included in the prior art are a wide range of techniques and systems for trading various types of financial instruments and securities such as stocks, bonds, currencies, options, futures, and derivatives. One of the more conservative trading techniques is the “buy-and-hold” technique which is a long term trading approach. The buy-and-hold technique requires buying a security, typically a stock, and holding the stock for many years in the hopes that over the long term, the price will rise and the stock can eventually be sold for a profit.

Statistical estimates of return rates using the buy-and-hold approach is an annual average of about 8 to 11 percent when measured over the last 40 to 50 years. One drawback associated with the buy-and-hold approach is that the holder of the stock must exercise a tremendous amount of patience and discipline over many years and sometimes through bear markets. A further drawback associated with the buy-and-hold approach is that the stock market may suffer a severe economic downturn losing a large share of its value and requiring years and sometimes decades to recover.

Another approach to stock trading is selecting “value stocks” which, for various reasons, currently trade at a low price relative to the fundamentals (e.g., large dividends, strong management, etc.) leading investors to believe that the stock has a large upside potential. Some of the reasons supporting the belief that such value stocks are performing poorly include bad press and poor earnings. However, because of solid fundamentals of the underlying company, investors believe that the stock price will rise in the near future with the investor then selling and profiting.

Another popular trading strategy is the market timing approach which is premised on predicting fluctuations in the market or fluctuation in the price of the security (e.g., stock) that is traded on the market. In market timing, buy and sell decisions are based on predicted price movements which, in turn, are based on trends in the market and which may be applied to specific stocks to predict price fluctuations. Market fluctuations may be based on fundamental analysis and/or technical analysis which are often used in combination with one another and with other trading approaches to make buying and selling decisions.

Fundamental analysis focuses on factors that are fundamental to the operation of the business or company that is represented by the stock. For example, the financial health of a company including the debt structure, sales volume, earnings, and asset allocation are some of the factors that may be considered in fundamental analysis. Other factors that are considered include the effectiveness and strength of company management, strength and number of competitors and available market share. These and other factors are considered in assessing the health of a company in relation to its competitors and the market in order to predict changes in the stock price.

Technical analysis is another tool that may be used in combination with fundamental analysis to predict price fluctuations of specific stocks. Instead of looking at management, markets and other fundamentals, technical analysis focuses primarily on historical and actual price behavior of the market or the stock that is traded on the market as a means to forecast trends or price fluctuations. Stock traders employing the market timing strategy can exploit the predicted trends in the markets and particular stocks by buying long at a low price and selling at a high price. Investors can also profit in bear markets by selling the stock short wherein the investor borrows stock and sells at a low price and then waits for the stock price to drop before buying back (i.e., paying for) the stock that was borrowed.

Day traders may employ any combination of the above-mentioned approaches to take advantage of price fluctuations occurring during a trading session or over several trading days by buying and selling stocks or other financial instruments. The rapid growth of the global computer network (i.e., the Internet) allows lay investors and institutional investors to monitor markets and execute trades anywhere in the world. However, the ability for day traders to profit is considered by some to be more difficult due to certain changes in the trading environment.

For example, a gradual reduction over the years between the bid and ask price of stocks (i.e., the bid/ask spread) has meant that traders must invest increasingly greater amounts of capital. Furthermore, short-term traders or day traders must typically execute a large number of transactions as compared to investors using the buy-and-hold approach. The large number of transactions required of day traders compensates to some degree for the transaction costs involved in each trade (e.g., broker commissions).

Although trading can be a stimulating and financially rewarding activity, the volume of trading and the capital investment required can make day trading intimidating to many people. Further contributing to the intimidation factor is that many day traders utilize a combination of various strategies including fundamental analysis, researching of value stocks, and learning various other strategies and trading approaches in order to maximize profit potential. While a certain amount of study and research is required before investing in any particular market or financial security (e.g., stocks), most investors have a limited amount of time to devote to research. Furthermore, due to the wide range of factors that can affect the direction of the market, investors must react quickly to market changes and price fluctuations in order to profit.

As mentioned above, because of the high level of discipline required and the need to act quickly, trading can be intimidating. Traders risk losing large amounts of money by acting on impulse or emotion such as fear or panic instead of making rationalized trading decisions based on objective data. Particularly for beginning traders, the lack of knowledge or experience with typical market patterns only increases the intimidation factor.

Familiarity with market behavior and the particular securities in which the trader is invested can reduce the intimidation factor such that trading decisions are based primarily on objective criteria such as company fundamentals, the health of the economy and trends. Traders can increase their success rate by having access to additional data that may be indicative of the direction or movement of a market and/or of a security that is traded on that market.

As can be seen, there exists a need in the art for a method for reducing the risk of financial loss in trading. More particularly, there exists a need in the art for a method for entering a trading position with increased confidence regarding the directional position of a security, such as by examining predicted fluctuations in the value of the security.

### BRIEF SUMMARY

According to an aspect of the present invention, there is provided a method of presenting predictive data of a security. The method comprises the steps of receiving historical data of the security such as from a data input. The historical data may include historical data values with price changes recorded over a time period. The method further comprises the steps of displaying the historical data on a user interface such as a graphical user interface (GUI). The security may be in the form of a stock although the security may be in a wide variety of other forms including stock options, bonds, mutual funds, currencies, futures, derivatives, commodities and various other securities well known in the art.

The historical data may include daily open, high, low, and close prices of the stock which are recorded over a selected time period. The time period over which the historical data is displayed on the user interface may be adjusted by means of a date range selector on the GUI. The historical data may be presented as a bar chart or as any other conveniently-viewable format including a line chart or a candlestick chart. The historical data may be displayed with other indices that may be presented with or superimposed over the historical data in order to allow for comparative analysis of the particular security or with other market data or other securities.

In a further aspect, the method of the present invention includes displaying limit values of the security on the user interface or GUI. The limit values may include incrementally greater and lesser values of a target value of the security. In the case of a stock, the limit values may be expressed as limit prices including incrementally greater and lesser values of the stock expressed as a percentage of the target price of the stock. The target price may be the most recent close price of the stock although the target price may be any other price including the open, high, low and current (e.g., intra-day) price of the stock.

The method further comprises displaying the predictive data for at least one of the limit values on the user interface. The predictive data comprises an edge which may be expressed as an increase or a decrease in the limit value and which is predicted to occur at the end of a hold period. For the case where the security is a stock, the edge may be expressed as a percentage increase or decrease in the most recent price (i.e., intra-day trading) price of the stock. The edge may be expressed as a percentage increase or decrease in the most recent close price of the stock and may be further expressed as a corresponding unit value to the percentage.

The predictive data may further include the probability 48 that the edge will occur at the end of the hold period. The hold period may comprise multiple hold periods and may be expressed in multiples of days. The edge and the probability 48 of occurrence of the edge are based upon the historical data such as on statistical analysis thereof. The edge may be expressed as a percentage or as a corresponding unit value or as a combination thereof. In addition, the edge and the probability 48 of occurrence thereof may be expressed in textual form and/or in graphical form. For example, the edge and probability 48 of occurrence thereof may be graphically displayed in chart form as a plot of percentage increase or decrease versus time (e.g., hold period) for a given target value or for multiple target values.

In a further aspect of the invention, the method may include simultaneously presenting or displaying past, present and predictive data of a security (e.g., a stock). The method may further comprise the step of displaying the predictive data for the current price of the stock on the GUI. In this arrangement, the predictive data includes the edge which is expressable as an increase or decrease in the current price and which is predicted to occur at the end of at least one hold period. The predictive data further includes the probability 48 that the edge will occur at the end of the hold period. As indicated above, the edge and the probability 48 of occurrence of the edge are based upon statistical analysis of historical data.

The simultaneous display of the past, present and predictive data may be presented in a floating bar which may be displayed as a pop-up window on the GUI. In the pop-up window, the limit value of the stock may be presented as the current or intra-day price of the stock such as during a trading session. The difference between the current price and the previous close price of the stock may be also displayed within the floating bar as a percentage. At least one and, more preferably, multiple hold periods may be displayed within the floating bar and may each include predictive data comprising the edge expressed as a percentage and/or unit value along with the probability 48 or likelihood of occurrence of the edge expressed as a percentage or other suitable arithmetic expression of the edge.

The appearance of the floating bar (i.e., pop-up window) may be prompted by activating a live sector radio button or other similar command feature on the display window of the GUI. Simultaneously, the user may prompt the appearance of a slider pop-up window which may be prompted by the user holding over listing of a particular hold period and corresponding predictive date in which the user is interested. The slider may contain the hold period and corresponding predictive data within the pop-up window in a larger or easier-to-read format. The slider may further include additional data regarding the stock such as average gain or loss. Information in the slider may be presented in numeric and/or graphic form in the same manner described above with reference to the edge and probability.

The user may also select from a watchlist selector in a risk profile selector button located within the slider such as along a bottom portion thereof. Upon selection of the risk profile selector button, a risk display window may appear as a pop-up window within the main window containing the historical data. The risk display window may graphically display the risk profile for a particular security such as a stock. The risk display window may include a textual and/or graphical illustration (e.g., as a bar chart) of at least one of first, second, and third standard deviations in the stock price. In this regard, the standard deviation data may be presented separately from the historical data and predictive data.

In a further aspect of the invention, the method may include presenting standard deviation data with the predictive data. The standard deviation data may be presented in a textual format and/or in a graphical format. For graphical formats, the standard deviation data may be presented as a plot of one or more standard deviations from the edge of one or more hold periods for a given target value. However, the standard deviation data may be presented on a separate window such as in a pop-up window, in the risk display window mentioned above, or in any other suitable manner. Regardless of the manner in which it is presented, the standard deviation data provides a further indication of the level of risk associated with entering a position in a particular stock or other security.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is an exemplary flow chart of a method for presenting predictive data of a security wherein the predictive data may be expressed as standard deviation;

FIG. 2 is an illustration of an exemplary graphical use interface (GUI) for displaying historical data, limit values, and predictive data of a particular security and further illustrating a plot of one standard deviation of a predicted increase or a decrease (i.e., an edge) in limit values for the security;

FIG. 3 is an exemplary GUI illustrating the graphical representation of the edges for different limit values predicted to occur at different hold periods; and

FIG. 4 is an exemplary GUI illustrating the display of a pop-up window of predictive data for one limit value.

### DETAILED DESCRIPTION

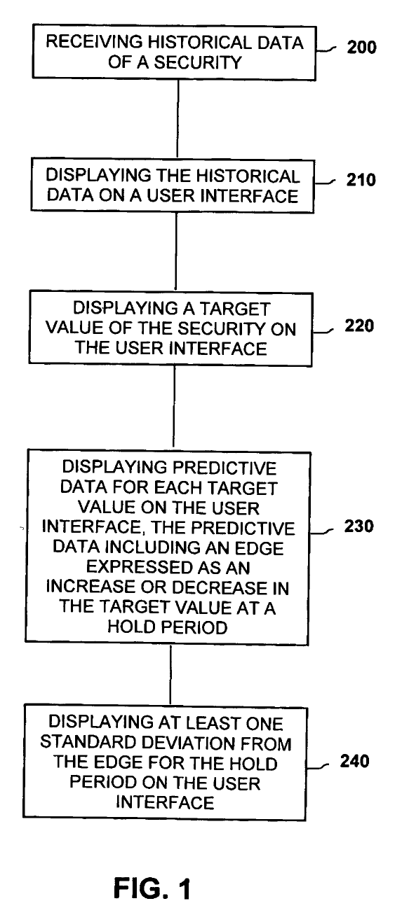

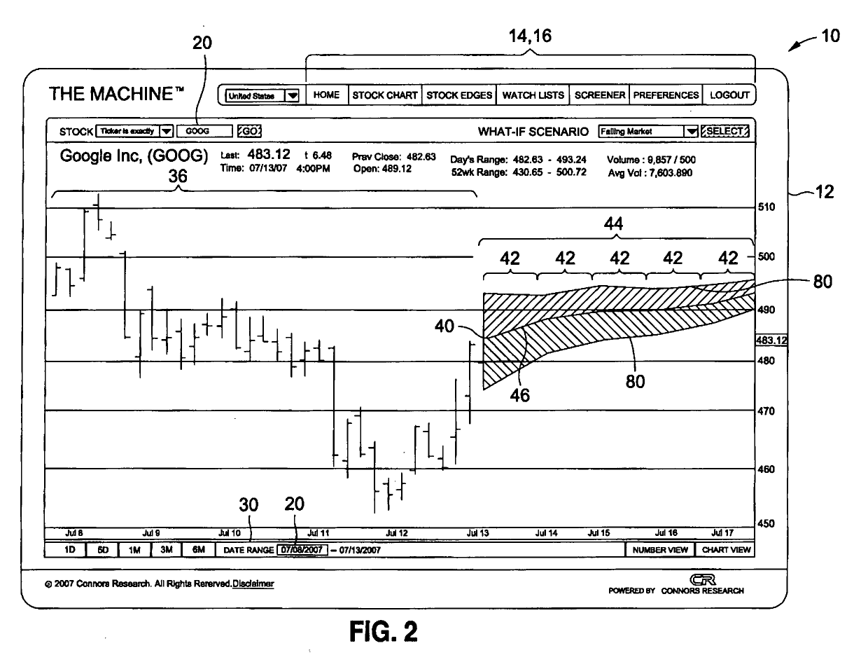

Referring now to the drawings wherein the showings are for purposes of illustrating preferred embodiments of the present invention only and not for purposes of limiting the same, FIG. 1 is a flow chart illustrating implementation of a method of presenting predictive data 44 of a security such as a stock wherein such predictive data 44 is based upon historical data 36 and wherein standard deviation 80 data may also be presented. As can be seen in FIGS. 2-4 and as described in greater detail below, predictive data 44 is preferably presented on a display window 12 of a graphical user interface 10 (GUI) to allow a user such as an individual trader or an institutional trader of financial instruments to observe the predictive data 44 as an aid in making trading decisions. As shown in FIG. 2, the standard deviation 80 data corresponding to the predictive data 44 may be simultaneously displayed as an aid for assessing the risk associated with the trading of a security.

The predictive data 44 may include the presentation of an edge 46 which represents an increase or a decrease in the value of the security and which is predicted to occur at the end of a hold period 42. The hold period 42 may be measured in any suitable time unit such as in units of days although other time units may be used. For individual traders, the predictive data 44 may help to reaffirm a decision to buy and/or sell a particular stock. For institutional traders, the predictive data 44 may be used to compare market trends. For example, the predictive data 44 may be used by a hedge fund trader as an indication of the directional position of the market such that the institutional trader may decide whether to hold or to enter a position. The predictive data 44 may also be used to compare recent trades made by institutional traders with predicted movements of a particular technology sector (e.g., oil, biotech), trading indices (e.g., Standard & Poor's 500) or other comparative parameters.

The presentation of standard deviation 80 data associated with the predictive data 44 as part of the methodology may serve as an additional parameter for characterizing the risk of a particular trade. Generally, the standard deviation 80 data as disclosed herein is the standard deviation 80 from the edge 46 for a given hold period 42. The edge 46 is based on a limit value 38 of the security and may include incrementally greater and lesser values of a target value 40 of the security. In the case of a stock, the limit values 38 may be expressed as limit prices and may include incrementally greater and lesser values of the stock expressed as a percentage of the target price of the stock. The target price may be the most recent close price of the stock although the target price may be any other price including the open, high, low and current (e.g., intra-day) price of the stock.

Generally, the standard deviation 80 of the edge 46 for a given hold period 42 is a representation of the likelihood that the value of the security will correspond to the predicted increase or decrease thereof. As such, the larger the standard deviation 80, the riskier the particular trade. As was previously indicated, the predicted increase or decrease in the value of the security and the probability 48 of its occurrence is based upon historical data 36 and may be expressed in graphical and/or numerical form such as in percentages, as a ratio, or in any other suitable numeric form. The predicted increase or decrease in the value of the security may also be expressed in graphical form such as in a bar chart or in any other suitable graphical representation. In like manner, the standard deviation 80 data may be presented in a graphical format as shown in FIG. 2. However, the standard deviation 80 data may be presented in a textual format.

As used herein, historical data 36 may relate to any type of measurable data. In this regard, historical data 36 may be interpreted to include any and all data having a quantifiable value. For example, historical data 36 may relate to financial market data such as historical stock prices, currency rates, and commodity prices. The historical data 36 may be received from a data input such as a live-data feed and/or a database which supplies the historical data 36. If the historical data 36 is related to a security such as a stock, in the case of a live data feed, the data input may supply real-time data concerning a particular stock. In the case of a database, the data input may supply pre-recorded data concerning a particular stock.

Referring to FIG. 1, the method comprises the step 200 of receiving historical data 36 of the security and the step 210 of displaying that historical data 36 on the GUI 10. An exemplary hardware environment upon which the methodology of the present invention may be implemented includes a computer and monitor as is well known in the art. The monitor graphically displays output from the computer to a screen or other suitable display. For example, the monitor may be similar to that which is provided in a television, portable media device, cell phone, laptop, palm pilot or any other suitable display device.

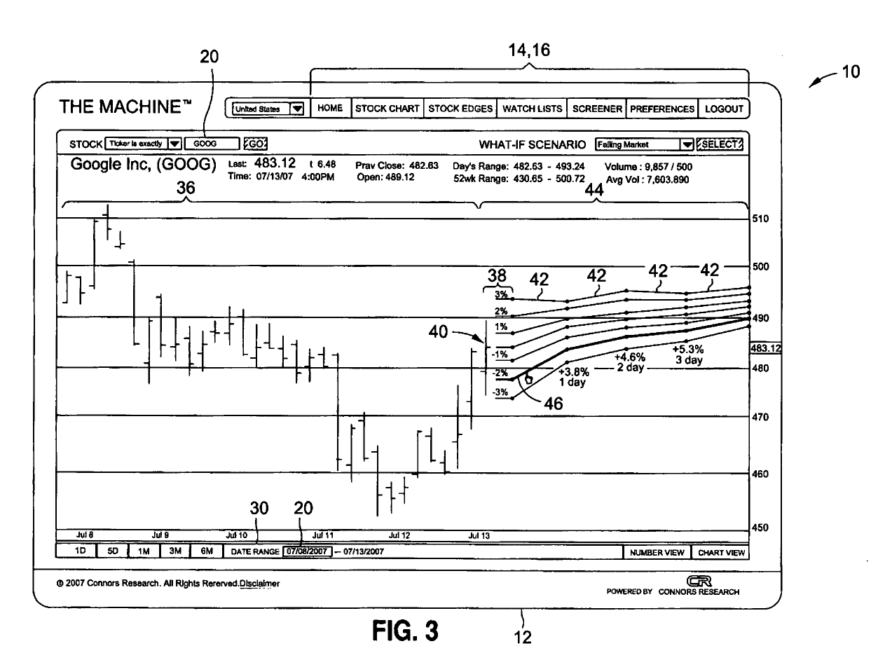

Input devices such as a conventional mouse and keyboard may also be included with the hardware in order to allow manipulation of the GUI 10 and to allow navigation between display screens such as those illustrated in FIGS. 3-8. Input from the mouse and/or the keyboard or other input device is translated in such a manner so as to allow manipulation of the screen. The user may access the graphical user interface (GUI 10) via any one of various methods well know to one of ordinary skill in the art and may include telephony based systems, cable (e.g., digital subscriber lines (DSL) and variations thereof, wire, optical, etc.), optical communications (e.g., infrared) and wireless forms of communications such as those based upon cellular, satellite, radio frequency (RF) transmission and other communication and signal mediums.

The GUI 10 may be hosted at a web address such that the GUI 10 is accessible through the Internet. Alternatively, the GUI 10 may be hosted at a personal computer (e.g. PC) or using other devices well known in the art. As will be described in greater detail below, the user may interact with the GUI 10 displayed on the monitor screen via the mouse and/or keyboard to navigate between display screens, to input text, and to activate various buttons to initiate certain data processing operations as well as to navigate between display windows.

Referring to FIGS. 2 and 3, the historical data 36 may be displayed on the GUI 10 in the form of a bar graph or line chart plotted against some time increment. As shown, the historical data 36 is shown plotted on the GUI 10 in the form of a bar chart. In the case of historical data 36 of a stock, bar charts typically include open, high, low, and close prices recorded over one unit of time (e.g., over one day or one hour). The historical data 36 for a stock may alternatively be illustrated in the form of a line chart, a candlestick chart or any other suitable graphical representation of the historical data. In addition, the historical data 36 may include other indices which may be superimposed over the chart such as the moving average of the stock.

As can be seen in FIGS. 2 and 3, the time period over which the historical data 36 is presented in the display window 12 is adjustable by means of a date range selector 30 shown in the lower left hand corner below the bar chart. A user may toggle between different time periods such as the one-day, five-day, one-month, three-month or six-month time period buttons or any other default time period. Alternatively, the user may manually enter a specific date range via the data entry box 20 shown as part of a date range selector 30 on the lower left hand corner of the bar chart of FIG. 3.

Referring back to FIG. 1, the method further comprises the step 220 of displaying the target value 40 of the security on the user interface. In the case of a stock, the target value 40 may be the target price of the stock. The target price may be the most recent close price of the stock although the target price may be any other price including the open, high, low and current (e.g., intra-day) price of the stock. As shown in FIG. 2, the target value 40 is expressed as the previous close price of the stock which is shown on the right hand margin of the window as 483.12.

In the exemplary illustration of the predictive data 44 shown in FIG. 2, shown are a plurality of hold periods 42 each of different duration for the target value 40. In the example shown, the hold periods 42 extend for four days from July 14 to July 17 as an example of different time periods for which the underlying stock may be held. The corresponding predictive data 44 comprising the edge 46 and standard deviation 80 thereof for the sequence of hold periods 42 is also presented in graphical format on FIG. 2 in the cross-hatched area. As shown, the standard deviation 80 is graphically plotted for the edges 46 that are predicted to occur for the consecutive series of hold periods 42. Each edge 46 may be presented as a unit value of the security which, in the case of FIG. 2, is a stock. In addition, each hold may be measured in terms of days although the hold period 42 may be measured in any time format such as in weeks and/or in months, etc.

Referring back to FIG. 1, the method further comprises the step 230 wherein predictive data 44 for the target value 40 may be displayed on the GUI 10. The predictive data 44 may include the edge 46 expressed as an increase or decrease in the target value 40 for a hold period 42. The method may further comprise the step 240 wherein the standard deviation 80 from the edge 46 for the hold period 42 may be displayed on the user interface in a manner similar to that shown in FIG. 2 and which is described above. For example, as shown in FIG. 2, for the hold period 42 from July 13 to July 17, the edge 46 is shown as a predicted increase in the stock for each hold period 42 (i.e., each day from July 13 to July 17). The line segments extend generally upwardly along a direction from left to right within the cross-hatched.

As was earlier mentioned, the cross-hatched area represents the standard deviation 80 from the edge 46 for the series of hold periods 42. The cross-hatched area above each upwardly extending line segment represents one standard deviation 80 from the edge. Likewise, the cross-hatched are located below the upwardly extending line segments represents one standard deviation 80 from the edge. As can be seen in FIG. 2, the standard deviation 80 forms a generally horizontally-oriented funnel shape indicating that the standard deviation 80 from the edge 46 decreases as the length of the hold period 42 increases. In general, a relatively large the standard deviation 80 corresponds to a riskier trade. In this regard and for the example shown in FIG. 2, the standard deviation 80 plot shown in FIG. 2 may indicate that the riskiness of entering a trading position is greater for a hold period 42 of a single day as compared to the riskiness of entering a trading position for a hold period 42 of multiple days. As was indicated above, the display of the standard deviation 80 data may provide an additional parameter for characterizing the risk of a particular trade.

Referring briefly to FIG. 3, shown is a display of the limit values 38 of the security on the user interface and a graphical representation of the corresponding predicted edges 46 for a sequence of hold periods 42 based on the limit values 38. The limit values 38 include at least one and, more preferably, a plurality of incrementally greater and lesser values of the target value 40. In the example shown, FIG. 3 displays three incrementally-greater limit values 38 and three incrementally-lesser limit values 38 which are all based on the target value 40. Each one of the limit values 38 may be expressed as a percentage and/or as a corresponding unit value of the percentage. The limit values 38 (e.g., percentages and/or corresponding unit values) may be illustrated in any suitable graphic form. The edges 46 for each of the hold periods 42 may optionally shown in textual format as a percentage change from the limit value 38 as well as in the graphic plot of the change in value for each hold period 42 and for each limit value. However, the edge 46 may be expressed in textual format as unit values of the security or in any other suitable format.

As shown in FIG. 3 for the limit value 38 of “−2%”, the edge 46 may also be shown in textual form by means of the series of boxes located along the edge 46 plot for the “−2%” limit value. As can be seen, for the “1 day” hold period, the box includes a textual display of the edge 46 (i.e., “+3.8%”) that is predicted to occur at the end of the “1 day” hold period 42. Likewise, textual displays of the predicted edges 46 for the “2 day” and “3 day” hold periods 42 are also shown as “+4.6%” and “+5.3%”, respectively. The textual display of the edge 46 corresponds to the graphical display via the line segments described above.

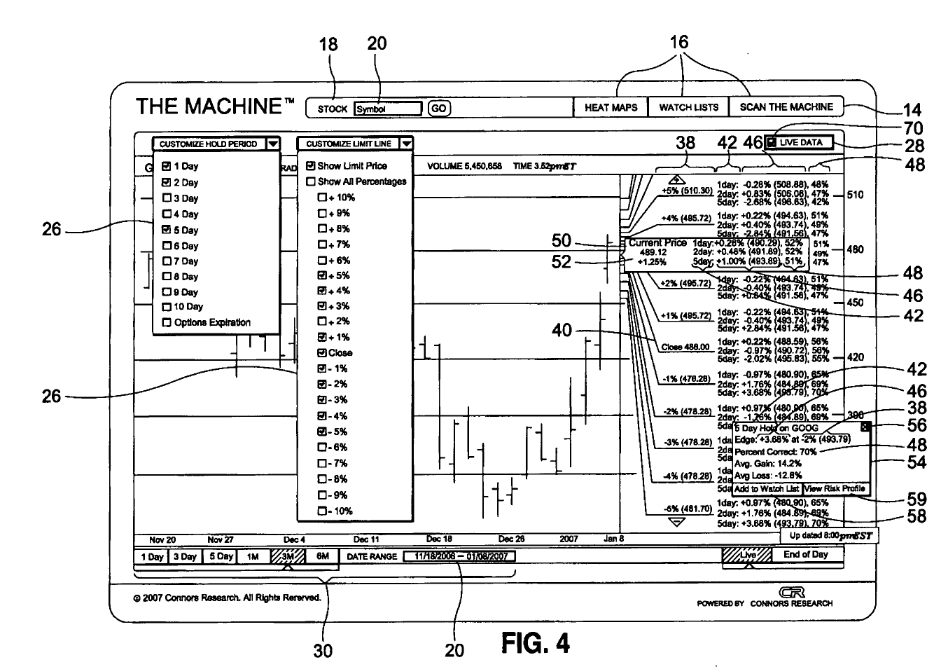

Referring to FIG. 4, the GUI 10 may be configured to provide a textual display of the historical data 36 and predictive data. In FIG. 4, the predictive data 44 is presented in entirely textual format and illustrates a display of the edge 46 and probability 48 of occurrence of the edge. This is in contrast to FIG. 3 which illustrates a graphical presentation of the predictive data. The presentation of predictive data 44 shown in FIG. 4 is disclosed and described in commonly-owned U.S. patent application Ser. No. 11/845,236 and entitled, METHOD OF PRESENTING PREDICTIVE DATA OF FINANCIAL SECURITIES, the entire contents of which is incorporated by reference herein.

As shown in FIG. 4, the GUI may includes a limit value selector 24 on the upper left hand corner of the display window 12 which includes a drop-down menu to allow for selection of any number of different percentages from minus ten percent to positive ten percent or any other percentage. The percentages may be selected by activating the radio button 70 or other suitable selection feature. The limit value selector 24 allows for selection of any one of the radio buttons 70 for the percentages and/or display of the close price in the limit value 38 column. Each of the limit values 38 may include a leader line which extends toward a bar indicating the trading activity for the stock for that particular trading day (i.e., open, high, low, close price).

As was earlier mentioned, the predictive data 44 is based upon the historical data 36 and is a prediction based on statistical analysis as to whether the stock price will increase or decrease at the end of the hold period 42. The hold period(s) 42 that are displayed for each limit value 38 may be adjusted by activating a hold period selector 22 located on the upper left hand corner of the display window 12 and which includes a drop-down menu or sub-menu 26 as best seen in FIG. 4 by which the user may select different hold periods 42. Furthermore, FIG. 4 also illustrates the drop-down menu including an options expiration feature to allow for display of the expiration date of call and put options for the stock.

Referring to FIG. 4, the predictive data 44 for the current price may be displayed in the floating bar 50 which may appear as a pop-up window. The pop-up window may be generated upon activation of the live selector 28 radio button 70 located on the upper right hand corner of the display window or by activation of the end-of-day (EOD) selector 32 located on the lower right hand corner of the display window. The floating bar 50 pop-up window includes the current prices of the stock for the example illustrated in FIG. 3 as well as the difference between the current price and the previous close price expressed as a percentage and/or which may be graphically illustrated, as mentioned above.

The floating bar 50 further may contain the predictive data 44 for the current price as shown in FIG. 4. The predictive data 44 may include a listing of a hold period(s) 42. The hold periods 42 listed in the floating bar 50 are preferably, but optionally, the same hold periods 42 that are displayed in the main window. In the floating bar 50, alongside each one of the hold periods 42 is the edge 46 and the probability 48 that the edge 46 will occur at end of the hold period 42. The edge 46 and the probability 48 of occurrence of the edge 46 are based upon the historical data 36.

Importantly, the floating bar 50 allows for simultaneous viewing of past, present and predictive data 44 of the stock on the user interface. With the floating bar 50, the user can observe the predictive data 44 based for the current or market price (i.e., present data 52) of the security during a trading session. The present data may also be displayed on a header 34 located above the historical data 36 and which may include the last trade (e.g., 489.12 in FIG. 3), volume and other stock data. For an investor who owns a long position in the stock or for an investor who wishes to sell short a particular stock, the simultaneous display of historical data 36, present data 52 and predictive data 44 provides an extra signal of confidence to reaffirm a decision to enter or forego a position.

Referring still to FIG. 4, the GUI 10 may also include a slider 54 which may appear as a pop-up window. The slider 54 displays predictive data 44 for a particular hold period 42 and may be provided in an easier-to-read format and allowing access to command features. The information presented in the slider 54 may be illustrated in numeric and/or graphic form in the same manner as was described above with reference to the edge 46 and probability 48 data. The slider 54 window may be prompted by several GUI 10 mechanisms well known in the art including by holding the cursor over the predictive data 44 of interest for a predetermined time period or by clicking on the data of interest. To close the slider 54, the user may select the close button 56 on the upper right hand corner of the slider 54 window or the slider 54 may be programmed to disappear after a predetermined time period or to disappear when the cursor is moved. The slider 54 may include additional data relevant to the predictive data 44. For example, the slider 54 may include the average gain and average loss for the stock at the edge 46. The slider 54 may include a watchlist selector 58 and a risk profile selector 59 as additional display option.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of presenting predictive data of a security, comprising the steps of:
receiving historical data of the security;
displaying a target value of the security on a user interface;
displaying predictive data for the target value on the user interface, the predictive data including an edge expressed as an increase or decrease in the target value at a hold period, the edge being based upon the historical data; and
displaying at least one standard deviation from the edge for the hold period on the user interface, the standard deviation being based upon the historical data.

2. The method of claim 1 wherein the standard deviation is presented in a textual format.

3. The method of claim 1 wherein the standard deviation is presented in a graphical format.

4. The method of claim 3 wherein the standard deviation is graphically plotted for a series of edges for a consecutive series of hold periods, each edge being presented as a unit value of the security, each hold period being measured in terms of days.

5. The method of claim 1 wherein the historical data, target value, predictive data and standard deviation are displayed simultaneously on the user interface.

6. The method of claim 1 wherein the hold period is comprised of multiple hold periods, each hold period having a corresponding edge, the standard deviation being displayed for each edge.

7. The method of claim 1 further comprising the step of:
displaying a limit value of the target value on the user interface, the limit values including one of an incrementally greater and lesser value of the target value;
displaying predictive data for the limit value on the user interface, the predictive data including the edge expressed as an increase or decrease in the limit value at a hold period; and
displaying the standard deviation from the edge for the hold period on the user interface.

8. The method of claim 7 wherein the limit value is expressed in percentages.

9. The method of claim 7 wherein the hold period is comprised of multiple hold periods, each hold period having a corresponding edge, the standard deviation being displayed for each edge.

10. The method of claim 1 wherein the security is in the form of at least one of the following: stocks, stock options, bonds, mutual funds, currencies, futures, derivatives, commodities.

11. The method of claim 1 wherein the historical data, target value, predictive data and standard deviation are graphically presented on the user interface.

12. The method of claim 1 wherein:
the security is a stock;
the historical data including daily open, high, low, and close prices of the stock recorded over a selected time period;
the target value being at least one of the open, high, low, close and current price of the stock.

13. A method of presenting past, present and predictive data of the security, comprising the steps of:
displaying the historical data of the security on a user interface;
displaying a target value of the security on the user interface;
displaying predictive data for the target value, the predictive data including an edge expressed as an increase or decrease in the target value at a hold period, the edge being based upon the historical data; and
displaying a standard deviation from the edge for the hold period, the standard deviation being based upon the historical data, the historical data, target value, predictive data and standard deviation being displayed simultaneously on the user interface.

14. The method of claim 13 wherein the hold period is comprised of multiple hold periods, each hold period having a corresponding edge, the standard deviation being displayed for each edge.

15. The method of claim 13 further comprising the step of:
displaying limit prices of the security on the user interface, the limit prices including incrementally greater and lesser values of the security expressed as a percentage of the target price; and
displaying predictive data for each limit price on the user interface, the predictive data including the edge expressed as an increase or decrease in the limit price at a hold period;
displaying the standard deviation from the edge for the hold period on the user interface.

16. The method of claim 13 wherein the target value is the most recent close price of the security.

17. The method of claim 13 wherein the edge is expressed as a percentage increase or decrease in the most recent price of the security.

18. The method of claim 13 wherein the security is in the form of at least one of the following: stocks, stock options, bonds, mutual funds, currencies, futures, derivatives, commodities.

19. The method of claim 13 wherein the historical data, target value, predictive data and standard deviation are presented in graphical form on the user interface.

20. The method of claim 13 wherein the historical data includes as at least one of an open, high, low, and close price of the stock.
